(19) United States
(12) Patent Application Publication
(10) Pub. No.: US 2006/0158980 A1
(43) Pub. Date: Jul. 20, 2006

(54) Method and apparatus for writing an optical disc

(75) Inventors: Bei Wang, Shanghai (CN); Wenying You, Shanghai (CN); Gongming Wei, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/564,540

(22) PCT Filed: Jul. 6, 2004
(86) PCT No.: PCT/IB04/51131

§ 371 Date: Jan. 12, 2006

(30) Foreign Application Priority Data
Jul. 17, 2003 (CN) 03178740.1

(51) Int. Cl. G11B 5/09

(52) U.S. Cl. 369/47.1; 369/59.1

(57) ABSTRACT

The present invention provides a method and apparatus for writing an optical disc. By means of storing the control information of the program obtained in one or more optical disc writing processes onto the optical disc or the assigned area of the writing means, converting the control information into control information compliant to a standard after finishing writing and storing control information compliant to a standard onto the optical disc. The present invention builds a friendly interface, overcomes the compatibility of standard and the interface designing problems brought about by the randomness of writing an optical disc, especially the real-time writing.

### TECHNICAL FIELD

The present invention relates to the field of optical storage, specifically to the method and apparatus for writing an optical disc.

### BACKGROUND TECHNIQUE

Lots of devices for writing an optical disc, writing formats and writing standards of an optical disc come forth in the field of writing an optical disc along with the development of the optical storage technique. It becomes a fashionable demand to be able to record the program information of the information media such as TV interactively on real time as the information-recording manner with individuation.

It is necessary to manage the stored programs by setting up the corresponding guide files in order to read and use the information stored on an optical disc easily.

For a product of optical disc, the arrangement and the design of the control information of the program on the optical disc can be performed daintily during editing and creating the optical disc. During creating a optical disc, the creator can design flowing steps, write script, edit user interface, partition menu, determine and link menu buttons and make subtitles etc, then prefabricate original edition and copy it, and write all of the information on an optical disc at one time. This process can make the control information of the program on the optical disc compliant to the corresponding standard and have the friendly user interface.

For a non-product of optical disc (such as an optical disc written on real time), however, it is impossible to predetermine the creating process for editing, designing and processing the information because of the randomness of writing time and the uncertainty of the information size, and it is usually impossible not to edit, create and write an optical disc until the size of information is large enough to fill it up. For example, when writing the TV serial plays played one set each day or the conversation program played on a special time per week, or writing the TV program being playing according to a temporary decision, it is impossible to have the creating process unless storing the whole program in somewhere first according to the executing method for writing optical disc on non-real time and then writing it on an optical disc with some managing files such as guide files after editing, and it is usually unlikely to write a program so short as to last several minutes on an optical disc just for convenience of program management. Of course, a user can usually find a required program within disorderly and unsystematic program snatches and play it without the information written on an optical disc on real time being edited, but the ensuing tanglesome work and crude interface suffered by the user make the greatly living optical disc-writing technique, especially the real time writing technique, unharmonious.

Therefore, it is necessary to provide the method and the apparatus thereof for establishing the standard, convenient and friendly menu function and the control information in the field of writing an optical disc, especially in the field of writing a non-product optical disc.

### SUMMARY OF THE INVENTION

The present invention provides the method and the apparatus for writing an optical disc thereof that can overcome the shortcomings of prior art and provide a standard and friendly user interface to users.

The method for writing an optical disc according to an embodiment of this invention includes the steps: writing a chosen program onto the optical disc and obtaining the control information of the program during this process; repeating the steps for writing programs on an optical disc and obtaining the control information if other programs need to be written on the same optical disc; and converting the obtained control information of the program in to the guide information or other control information compliant to a standard and storing the converted control information compliant to a standard on the optical disc if all of the programs which need to be written on the same optical disc have been written, thereby making the control information of the program compliant to the corresponding standard and have the friendly user interface.

Apparatus for writing an optical disc according to another embodiment of this invention includes means for storing program on an optical disc; means for obtaining the control information of the program during the writing process; means for converting the control information of the program in to the control information compliant to a standard and storing the converted control information compliant to a standard on the optical disc. The apparatus for writing an optical disc can also comprise an enencoding means for converting the analog signals into the digital signals, the enencoding means being unnecessary or being on stand-by if the program to be written consists of the digital signals.

The method and the apparatus thereof provided by this invention realize the conversion from the control information of the program obtained during writing process to the control information compliant to a standard, and can be used to create the menu and guide files with individuation, etc. and set up the friendly user interface.

Other aims and achievements of this invention will be more apparent and the invention will be understood more exactly by referring to the following description with the accompanying drawings and the claims.

### BRIEF DESCRIPTION OF DRAWINGS

This invention will be explained particularly in detail with reference to the examples and the accompanying drawings.

FIG. 1 is a schematic diagram of the information storage area of an optical disc;

FIG. 2 is a block diagram of an embodiment of the apparatus for writing an optical disc according to this invention that is used to write program;

FIG. 3 is a flow chart of the embodiment of the method for writing an optical disc according to this invention;

FIG. 4 is a diagram of the DVD-writing format in which the program is written according to this invention; and

FIG. 5 is a diagram of the SVCD format in which the program is written according to this invention.

The like reference numerals indicate the similar or corresponding features and functions in all accompanying drawings.

### DETAILED DESCRIPTION OF THE PREFERRED EMBODIMENTS

According to the method provided by this invention, an assigned area can be defined for storing the obtained control information of the program during writing program on an optical disc. This assigned area can be defined on the optical disc, in the storage area of such as the hard disc or the top-set of the writing device of an optical disc, or in other storage media. The information stored in the assigned area will be converted to the control information compliant to the standard.

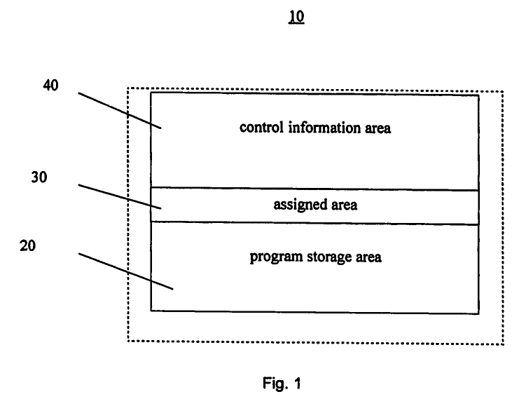

FIG. 1 shows a schematic diagram of the information storage area of an optical disc. The information storage area of optical disc 10 includes three areas: program storage area 20 for storing the content of programs; assigned area 30 for storing the control information of the program obtained during writing the program; control information area 40 for storing the system files, program guide files, menu files and other control information files of the optical disc.

The control information of the program stored in assigned area 30 is the raw information which is not processed and does not need to be provided to the optical disc-playing means to read, so that the assigned area can be defined in the areas that can not be recognized by the optical disc-playing means, for example, in the sectors of an optical disc that can not be recognized by the optical disc-playing means. After the end of writing programs, the control information stored in assigned area 30 will be converted to the control information compliant to a standard and the converted one is stored in area 40. The conversion can be performed using the methods for processing and editing the raw control information of the program into the information compliant to a standard as used in the conventional optical disc creating process.

This assigned area 30 only occupies a very small portion of the accessible storage areas of an optical disc, not affecting much the regular storage of programs on the optical disc, so that it is relatively preferred to define this assigned area on the optical disc. In this case, the control information of the program is stored on the same optical disc with the content of programs, so that the users do not need to worry about the loss of the program control information, meanwhile, it is very easy to search the original control information during converting the control information. For example, when a user travels or visits in some other places, he can use another writing device of an optical disc to write the programs onto an optical disc, which is partly full, and needs not to worry, that the control information of the program would be lost or difficult to search because it does not accompany the optical disc. If an user always uses the same writing device of an optical disc to write one optical disc, for example, to write TV serial plays one set each day, it is possible to define this assigned area in the hard discs or the top-set box of the writing device of an optical disc, or even in other storing media.

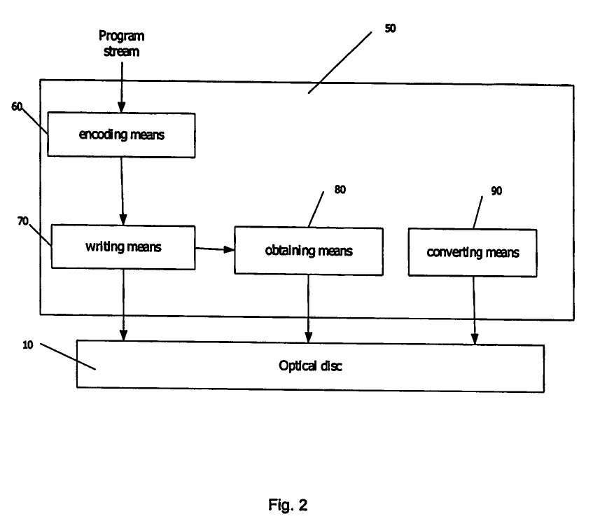

FIG. 2 shows a block diagram of an embodiment of a writing apparatus of an optical disc according to this invention. During the process of writing program, for example, the process of writing the TV programs being broadcast, the program is input into writing apparatus of an optical disc 50 in the manner of analog signals, the analog signals are encoded into the digital signals by encoding means 60, and the digital signals are stored in the program storage area of the optical disc by the writing means 70.

During writing the program on an optical disc, obtaining means 80 obtains the program control information, such as the encoding type of the program signals, the address of I frame, the bit-rate of the encode stream, the broadcasting time, the initial address of the program information and like, and stores them in assigned area 30 of the optical disc. The control information of the program can also be obtained by obtaining means 80 after the end of writing program. This information obtaining procedure can be performed using the methods for obtaining the control information of the program as used in the conventional optical disc creating process.

After the end of writing an optical disc, that is, after the end of writing all the programs needed and being able to be written on the optical disc, the control is converted to the control information compliant to a standard such as DVD or SVCD disc standards by converting means 90 and the converted one is written in the control information area 40 of optical disc 10. This conversion of the control information to the control information and the guiding files compliant to a standard can be performed using the methods as used in the conventional optical disc creating process.

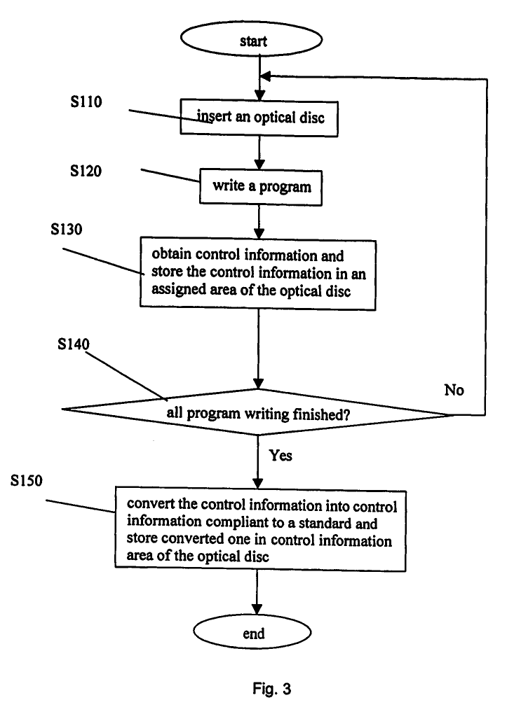

FIG. 3 shows a flow chart of an embodiment of the method for writing an optical disc according to this invention. Firstly, a write-enable optical disc 10 is inserted into the writing device of an optical disc (step S110) to start writing program. The optical disc can be CD-R optical disc, DVD+R optical disc (the optical disc that can be written once and only once) or CD-RW optical disc, DVD+RW optical disc (the optical disc that can be written repeatedly). The chosen program is written onto the optical disc according to the conventional optical disc-writing method (step S120).

The control information of the program generated during writing program is obtained by the writing device of an optical disc and stored in the assigned area of the optical disc (step S130). The control information of the program includes the encoding type of the signals, the address of I frame, the bit-rate of the encode stream, the broadcasting time and the initial address of the program, etc.

When the program writing process is over, the writing device of an optical disc will determine whether it is needed to write other programs on this optical disc (step S140) according to user's choice. If so, for example, it is needed to write other programs on another time, the steps 110 to 130 will be repeated. If not, that is, all of the programs which need to be written have been written on the optical disc, the control information stored in assigned area 30 will be converted to the control information files such as guide files, menu files, etc compliant to the standard, and the converted information will be stored in control information area 40 (step S150). The image of first I frame or other chosen I frame of every program can be converted into a standard interactive menu and like during the converting process.

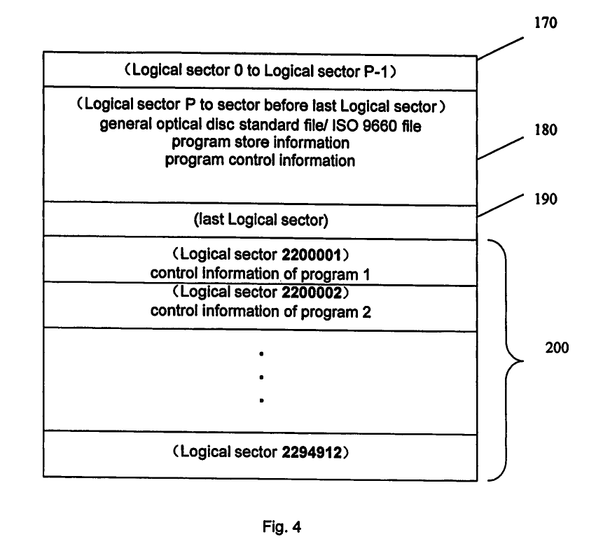

FIG. 4 shows a diagram of an embodiment of the DVD-writing format in which the program is written according to this invention. Area 170 covers the area from sector 0 to sector P, being the system files area assigned by DVD-Video standard, which is used to store IS09660 system files, UDF system files, etc, wherein P is serial number of sector.

Area 180 covers the area from sector P to a sector before the last logical sector (Last LSN-1 sector, “Last LSN” is the abbreviation of “Last logical sector number”), which is used to store UDF files (“UDF” is the abbreviation of “Universal Disk Format”) or IS09660 standard files and the program data. The program data include the content of program and the program control information, such as the program control files, guide files, menu files, etc.

Sector 190 is the last logical sector. The sectors after sector 190, such as the logical sectors after the last logical sector 2200000 in this example, cannot be identified by optical disc-Playing means, but can be used to write data by the writing device, so that it is suitable to the assigned area, which will be described in more detail below.

Area 200 is an assigned area for storing the control information of the program obtained during the writing process. The initial address of area 200 can be adjacent closely to sector 190, and also can be defined using other address after sector 190 with some sector spaces being held in area 200 according to the requirement. The initial address of assigned area 200 in this example is 2200001. When writing is over, the control information stored in area 200 will be converted to the control information compliant to the standard. The control in formation stored in area 200 should be enough to be converted to all kinds of information control files compliant to DVD-Video standard, such as video information VIDEO-TS.IFO files, audio information AUDIO-TS.IFO files, video VIDEO-TS.VOB files, VTS-01-0.IFO files on the information of the assembled video files names and like.

The proportion of whole storage space of optical disc assigned area 200 accounts for can be estimated using the equation below, being 4% approximately and will not cause great influence to writing an optical disc.
P=(Ns−2200001)/Ns

wherein P is the proportion of whole storage space of an optical disc assigned area accounts for;

Ns is the quantity of whole sectors on DVD, being 2294912 in this example;

2200001 is the initial address of assigned area 200 in this example

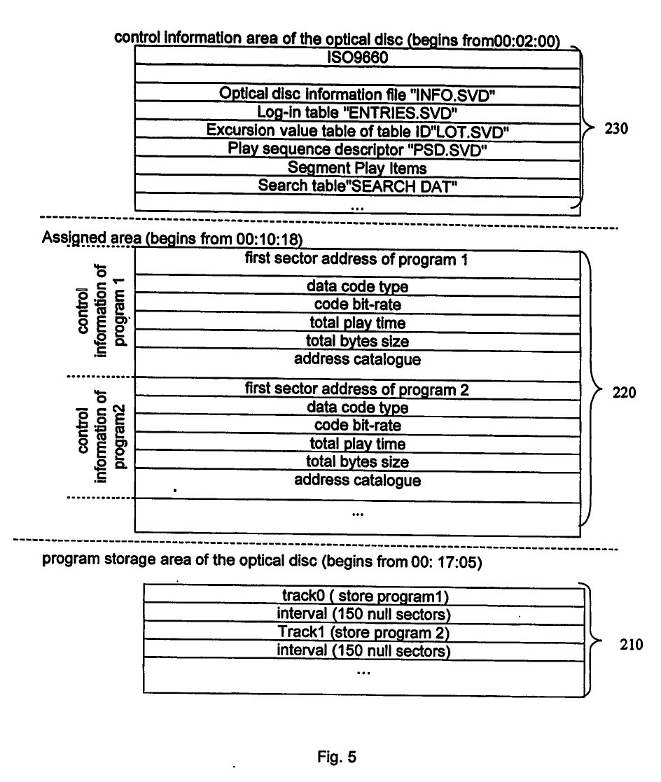

FIG. 5 shows a diagram of an embodiment of a SVCD-writing format in which the program is written according to this invention. The initial address of program storage area 210 is 00:17:05 in this example, and can be other address according to demand. Area 210 is used to store program information that is written on real time. Program 1 and program 2 are stored in program track 0 and program track 1 respectively. The space of 150 bytes between two program tracks is demanded by SVCD standard.

The initial address of assigned area 220 for storing the control information of the program is 00:10:18, and can be other address according to demand. The control information of the program of program 1 and the control information of the program of program 2 are listed in area 220 corresponding to program tracks 0 and 1 in program storage area 210. The control information in area 220 includes the data encoding type of the program encodes, the bit-rate of encode, first sector address of program stream, total playing time of program, size of total bytes, address catalogue, image of I frame, address of I frame, etc.

The initial address of optical disc control information area 230 for storing the basic guide information demanded by SVCD standard is 00:02:00 and also can be other address according to demand. The control information files stored in area 230 which conform with corresponding standard include the files such as optical disc information files (INFO.SVD), log-in list (ENTRIES.SVD), excursion value list of table ID (LOT.SVD, ID is the mark number of the playing sequence table), playing sequence descriptor (PSD.SVD), segment playing items, search table (SEARCH DAT), etc.

During the writing process, the selected program will be stored in program storage area 210 of the optical disc according to SVCD standard, and the encoded image of I frame, address and other control information of the program obtained will be stored in assigned area 220 every certain interval time (e.g. 0.5 second). If other programs need to be written on the same optical disc, the control information of the program created during the writing process will be stored in assigned area 220 too.

When optical disc writing is finished, the control information stored in assigned area 220 will be converted to the control information compliant to the SVCD standard and the converted information is stored in area 230. During the converting process, the image of first frame in every program track or a certain image of I frame of the program can be selected to for m the interactive menu, the basic guide information function files and other control information files can be formed and the friendly user interface can be set up.

The proportion of whole storage space of optical disc assigned area 220 accounts for can be estimated with the equation below:
P=NM×(9+3×T/0.5)/(650×1024×1024)

wherein P is the proportion of whole storage space of an optical disc the assigned area accounts for;
NM is the quantity of the program tracks;
T is the total playing time, its unit is second.

Supposing there are three program tracks and the total playing time is 30 minutes, according to above equation, the proportion of whole storage space of an optical disc the assigned area accounts for is less than 0.005%, being too small to affect the storage of programs on the optical disc.

The method and the apparatus for writing optical disc thereof provided by this invention, with which the control information of the program can be stored according to the demanded standard, fit for the different standards, such as SVCD standard, DVD-Video standard and other optical disc standards; being suitable to the creation of an optical disc, especially to optical disc-writing on real time; being suitable to the optical disc that can be written repeatedly, especially to the optical disc that can be written only one time. According to the invention, writing an optical disc will not be restricted to time, and it is unnecessary to predetermine the corresponding creating process before writing program to ensure the friendly and standard user interface, guide files and like.

While this invention is described with reference to the embodiment, it is apparent for those skilled in the art to make alternatives, modifications and variations according to the content described above. Therefore, all of these alternatives, modifications and variations should fall in spirit and scope of the claims of this invention.

1. A method for writing an optical disc, comprising:
(a) writing a program onto the optical disc;
(b) obtaining control information of the program; and
(c) converting the control information of the program into control information compliant to a standard and storing the control information compliant to a standard on the optical disc.

2. The method according to claim 1, before step (c), repeating step (a) and (b) in order to write other programs.

3. The method according to claim 1, further comprising: storing the control information of the program in an assigned area.

4. The method according to claim 3, wherein the assigned area is on the optical disc.

5. The method according to claim 4, wherein the assigned area on the optical disc is in the area unable to be identified by optical disc player.

6. The method according to claim 3, wherein the assigned area is in the storage area of the writing device.

7. The method according to claim 6, wherein the assigned area is in the storage area of the hard disc of the writing device.

8. The method according to claim 6, wherein the assigned area is in the storage area of the set-top terminal of the writing device.

9. The method according to claim 1, wherein the control information comprises starting address of the program.

10. The method according to claim 9, wherein the control information comprises data encoding type of the program.

11. The method according to claim 1, wherein the control information further comprises I frame of image.

12. The method according to claim 1, wherein the control information comprises an address of I frame of image.

13. The method according to claim 1, wherein the control information comprises starting address of the program and I frame of image.

14. An apparatus for writing an optical disc, comprising,
means for writing a program onto the optical disc;
means for obtaining control information of the program; and
means for converting the control information of the program into control information compliant to a standard and storing the control information compliant to a standard on the optical disc.

15. The apparatus according to claim 14, further comprising encoding means for converting analog signals into digital signals.
